(19) United States
(12) Patent Application Publication
(10) Pub. No.: US 2014/0013975 A1
(43) Pub. Date: Jan. 16, 2014

(54) METAL-BACK PRINTING BLANKET HAVING A COVER LAYER AND METHOD OF MAKING SAID PRINTING BLANKET

(71) Applicant: CONTITECH ELASTOMER-BESCHICHTUNGEN GMBH, HANNOVER (DE)

(72) Inventors: Detlef Roeder, Kaltenburg-Lindau (DE); Stefan Fuellgraf, Duderstadt (DE)

(73) Assignee: CONTITECH ELASTOMER-BESCHICHTUNGEN GMBH, HANNOVER (DE)

(21) Appl. No.: 14/027,699

(22) Filed: Sep. 16, 2013

Related U.S. Application Data
(63) Continuation of application No. PCT/EP2012/050764, filed on Jan. 19, 2012.

(30) Foreign Application Priority Data
Mar. 16, 2011 (DE) 10 2011 001 317.2

(51) Int. Cl. B41N 10/04

(52) U.S. Cl. CPC B41N 10/04
USPC 101/368; 156/60

(57) ABSTRACT

A metal-back printing blanket (2) includes a printing layer (4), a metal foil (10), a cover layer (14) which is bonded via an adhesive layer (12) to that surface of the metal foil (10) which faces away from the printing layer (4). The cover layer (14) is made of a nonwoven fabric.

### CROSS REFERENCE TO RELATED APPLICATIONS

This application is a continuation application of international patent application PCT/EP2012/050764, filed Jan. 19, 2012, designating the United States and claiming priority from German application 10 2011 001 317.2, filed Mar. 16, 2011, and the entire content of both applications is incorporated herein by reference.

### FIELD OF THE INVENTION

The invention relates to a metal-back printing blanket which includes the following layers: a printing layer; a metal foil; and, a cover layer which is connected via an adhesive layer to that surface of the metal foil which faces away from the printing layer. The invention also relates to a method for making a metal-back printing blanket of this type.

### BACKGROUND OF THE INVENTION

A printing blanket of the abovementioned type is known, for example, from United States patent application publication 2010/0236434 A1. In the metal-back printing blanket which is known from this publication, the cover layer includes a plastic foil which is adhesively bonded to the metal foil by way of a hot-melt adhesive. The printing blanket is clamped onto an impression cylinder for printing by projecting lengths of the metal foil in a known way. During a printing operation, the printing layer of the printing blanket is washed with a washing agent for cleaning purposes. It can occur here that washing agent gets in between the metal foil and the impression roll. The washing agent is then pressed partially between the metal foil and the plastic film and is distributed in the peripheral direction of the printing blanket as a result of the rotation of the impression roll during a later printing operation. It can then occur that the hot-melt adhesive is detached locally and the plastic film is detached from the metal foil in these regions. This leads to swelling of the printing blanket and to an impairment of the printed image in these regions.

### SUMMARY OF THE INVENTION

It is an object of the invention to provide a metal-back printing blanket wherein the risk of the adhesive layer detaching is low.

The metal-back printing blanket of the invention includes: a printing layer; a metal foil having a surface facing away from the printing layer; a cover layer of a nonwoven fabric; and, an adhesive layer bonding the cover layer to the metal foil at the surface thereof.

The object is achieved by virtue of the fact that the cover layer comprises a nonwoven fabric. The advantage of the invention is that, on account of the configuration of the cover layer as nonwoven fabric, the liquid washing agent can be distributed uniformly between the metal foil and the impression or printing cylinder. Here, the washing agent is absorbed by the nonwoven fabric, since the nonwoven fabric is open-pore. The washing agent therefore cannot detach the adhesive layer. Furthermore, local pressure increases between the metal foil and the impression cylinder cannot occur on account of the washing agent, which local pressure increases lead to detachment of the cover layer from the metal foil. A further advantage of the invention is that a cover layer in the form of a nonwoven fabric has a low flexural stiffness and the printing blanket can therefore be mounted simply on the impression cylinder.

According to a feature of the invention, the adhesive layer penetrates the cover layer in regions, which is readily possible on account of the configuration of the cover layer as nonwoven fabric. The advantage of the development is that, as a result of the penetration by the adhesive layer, the cover layer is connected in a positively locking or form-tight manner to the adhesive layer in addition to the adhesive connection. As a result, particularly long-term attachment of the cover layer to the metal foil of the printing blanket is ensured.

According to another feature of the invention, the adhesive layer penetrates from 50% to 90% of the thickness of the cover layer. The advantage of this development is that, in the case of penetration of this type, a particularly secure attachment of the cover layer to the metal foil is achieved. A further feature of the invention provides that the cover layer made from nonwoven fabric has no or only little compressibility in the region of the penetration, which leads to increased stability of the printing blanket in this region. Nevertheless, the cover layer made from the nonwoven fabric can continue to absorb moisture, since the nonwoven fabric is not penetrated completely by the adhesive layer.

Any desired nonwoven fabric, for example paper, can be selected for the configuration of the cover layer. According to still another feature of the invention, the cover layer is, however, preferably a synthetic nonwoven fabric. The advantage of this development is that a synthetic nonwoven fabric does not swell or swells only slightly during the absorption of moisture, and therefore no change in thickness of the printing blanket occurs during the absorption of moisture. A further advantage of the feature is that a synthetic nonwoven fabric has a high long-term durability.

According to the invention, every adhesive which is suitable for attaching the cover layer to the metal foil can be selected for the adhesive layer. Both physically bonding and chemically bonding adhesives may be suitable for this purpose. According to another feature of the invention, the adhesive layer is preferably configured as a hot-melt adhesive, however. The advantage of this feature is that the cover layer made from nonwoven fabric can be connected particularly simply and firmly to the metal foil with the aid of a hot-melt adhesive. This is the case, in particular, when the cover layer is configured from a synthetic nonwoven fabric, since a hot-melt adhesive is particularly suitable both for adhesively bonding metal and for adhesively bonding plastic. Finally, a further feature of the invention is that the hot-melt adhesive is softened by pressure and heat during the production of the printing blanket and can penetrate particularly satisfactorily in the process into the nonwoven fabric of the cover layer. In addition to the adhesively bonded connection, a positively locking or form-tight connection between the adhesive layer and the cover layer therefore additionally occurs.

An object of the invention is also to provide a method for making a metal-back printing blanket of the type described above.

The method of making the above-described metal-back printing blanket includes the steps of:

coating said metal foil with said adhesive layer on said surface facing away from said printing layer;

applying said cover layer of nonwoven fabric to said adhesive layer with said cover layer being at least twice the thickness of said adhesive layer; and,

activating said adhesive layer to cause said adhesive layer to penetrate said cover layer in regions thereof to bond said cover layer to said metal layer.

Since the cover layer is at least twice as thick as the adhesive layer, the adhesive layer penetrates the cover layer only in regions during the production of the metal-back printing blanket. The penetration in regions ensures firstly that the cover layer is bonded reliably to the metal foil. Secondly, the fact that part of the cover layer is not penetrated completely by the adhesive layer ensures that a sufficiently large region remains in the cover layer for the absorption of moisture.

According to still another feature of the invention, a hot-melt adhesive is preferably used in the abovementioned method. The advantages which have already been described above are achieved in this way.

### BRIEF DESCRIPTION OF THE DRAWING

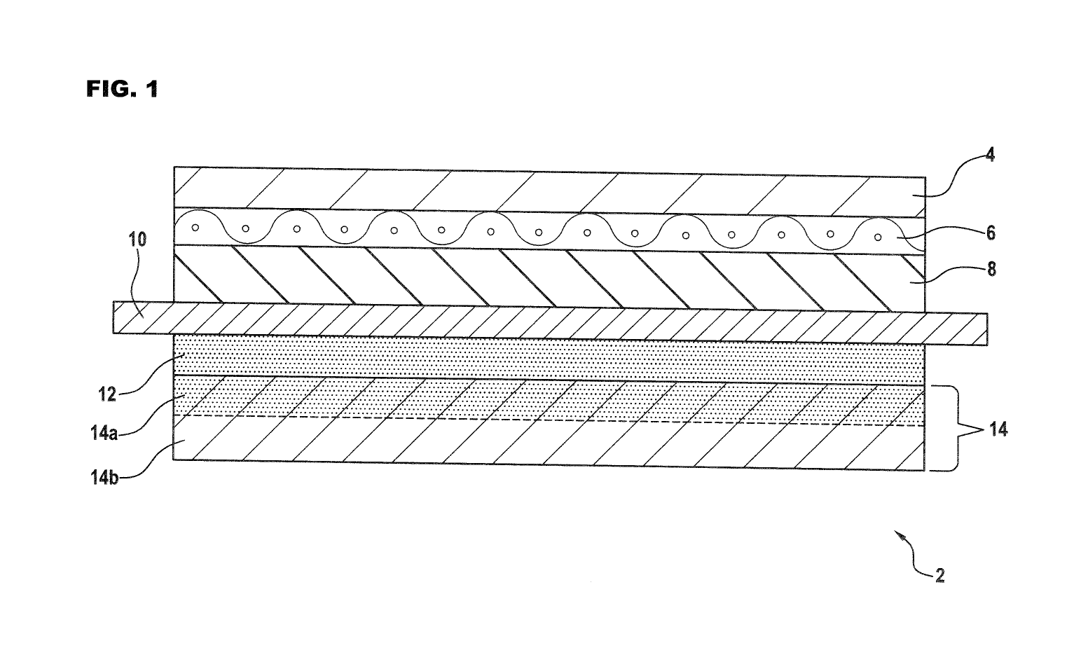

The invention will now be described with reference to the single figure of the drawing (FIG. 1) which shows a cross section of a metal-back printing blanket of the invention.

### DESCRIPTION OF THE PREFERRED EMBODIMENTS OF THE INVENTION

FIG. 1 shows a metal-back printing blanket 2 having a printing layer 4, a woven fabric layer 6, a compressible layer 8, a metal foil 10, an adhesive layer 12 and a cover layer 14. In addition to the woven fabric layer 6, the printing blanket 2 can also have further or alternative layers. It is likewise possible to omit the woven fabric layer 6. All the layers of the metal-back printing blanket 2 are bonded to one another via adhesively bonded connections. The metal foil 10 protrudes at both edges of the printing blanket beyond the other layers 4, 6, 8, 12 and 14, with the result that free metal foil edges are produced. With the aid of the metal foil edges, the metal-back printing blanket 2 is clamped onto an impression roll in a known way. The cover layer 14 of the metal-back printing blanket includes a nonwoven fabric, preferably a synthetic nonwoven fabric. A hot-melt adhesive in the form of a film is preferably used in the adhesive layer 12. The hot-melt adhesive is heated during the production of the metal-back printing blanket, and the adhesive layer 12 is connected to the cover layer 14 under the action of heat and pressure. Here, hot-melt adhesive from the adhesive layer 12 penetrates into the cover layer 14, with the result that the cover layer 14 is penetrated over the full area by the adhesive in a region 14a which adjoins the adhesive layer 12. The thickness of the penetration is at least 50% and at most 90% of the thickness of the cover layer 14, that is, the region 14a is at least exactly as thick as or thicker than that region 14b of the cover layer 14 which is not penetrated by adhesive. The cover layer 14 is configured to be at least twice as thick as the adhesive layer 12, in order to ensure a corresponding penetration. For example, an adhesive layer in the form of a foil with a thickness of 0.03 mm and a cover layer with a thickness of 0.15 mm can be selected.

It is understood that the foregoing description is that of the preferred embodiments of the invention and that various changes and modifications may be made thereto without departing from the spirit and scope of the invention as defined in the appended claims.

### LIST OF ELEMENTS

### (Part of the Description)

2 Metal-back printing blanket
4 Printing layer
6 Woven fabric layer
8 Compressible layer
10 Metal foil
12 Adhesive layer
14 Cover layer

What is claimed is:

1. A metal-back printing blanket comprising:
a printing layer;
a metal foil having a surface facing away from said printing layer;
a cover layer of a nonwoven fabric; and,
an adhesive layer bonding said cover layer to said metal foil at said surface thereof.

2. The metal-back printing blanket of claim 1, wherein said adhesive layer penetrates said cover layer in regions thereof.

3. The metal-back printing blanket of claim 2, wherein said cover layer has a predetermined thickness and said adhesive layer penetrates 50% to 90% of said thickness of said cover layer.

4. The metal-back printing blanket of claim 1, wherein said cover layer is a synthetic nonwoven fabric.

5. The metal-back printing blanket of claim 4, wherein said adhesive layer is configured as a hot-melt adhesive.

6. The metal-back printing blanket of claim 1, wherein said adhesive layer penetrates said cover layer in some regions thereof while leaving sufficiently large regions in said cover layer for the absorption of moisture.

7. A method of making a metal-back printing blanket including a printing layer; a metal foil having a surface facing away from said printing layer; a cover layer of a nonwoven fabric; and, an adhesive layer bonding said cover layer to said metal foil at said surface thereof; the method comprising the steps of:
coating said metal foil with said adhesive layer on said surface facing away from said printing layer;
applying said cover layer of nonwoven fabric to said adhesive layer with said cover layer being at least twice the thickness of said adhesive layer; and,
activating said adhesive layer to cause said adhesive layer to penetrate said cover layer in regions thereof to bond said cover layer to said metal layer.

8. The method of claim 7, wherein said adhesive layer is configured as a hot-melt adhesive.
